(19) United States
(12) Patent Application Publication
(10) Pub. No.: US 2014/0179855 A1
(43) Pub. Date: Jun. 26, 2014

(54) THERMOPLASTIC COMPOSITIONS, METHODS OF MANUFACTURE, AND ARTICLES THEREOF

(71) Applicant: SABIC INNOVATIVE PLASTICS IP B.V., Bergen op Zoom (NL)

(72) Inventors: Tony Farrell, Bergen op Zoom (NL); Andries J.P. van Zyl, Bergen op Zoom (NL); Johannes Hubertus Gabriel Marie Lohmeijer, Hoogerheide (NL)

(73) Assignee: SABIC INNOVATIVE PLASTICS IP B.V., Bergen op Zoom (NL)

(21) Appl. No.: 13/721,842

(22) Filed: Dec. 20, 2012

(51) Int. Cl. C08L 67/03

(52) U.S. Cl. CPC C08L 67/03
USPC 524/494; 524/508; 156/272.8

(57) ABSTRACT

A laser weldable composition made from a process of melt blending a combination of a partially crystalline thermoplastic polyester component such as poly(butylene terephthalate), an amorphous thermoplastic polycarbonate having a Fries rearrangement of greater than 150 to 10,000 ppm, and a filler such as glass fiber. The laser weldable composition has a polycarbonate aryl hydroxy end-group content of at least 300 ppm and provides improved near infrared transmission at 960 nanometers. A method welding components made from the weldable composition and welded articles made therefrom are also disclosed.

### BACKGROUND

This disclosure relates to thermoplastic compositions, in particular laser-weldable thermoplastic compositions, methods of manufacture, and articles thereof.

Thermoplastic compositions are used in the manufacture of a wide variety of products, including laser-welded products. Laser welding of two polymer parts by transmission welding requires one of the polymer parts to be substantially transparent to laser light for its transmission to the welding interface, and the other part to absorb a significant amount of the laser light, thereby generating heat for welding at the interface of the parts. External pressure is applied to ensure uninterrupted contact between the surfaces of the parts, and heat conduction between the parts results in the melting of the polymers in both the absorbing and the transmitting parts, thereby providing a weld at the interface.

Laser light of near-infrared (NIR) wavelength is used for welding. The level of NIR transmission through the transparent part should allow sufficient laser-light density to arrive at the interface to facilitate effective and rapid welding. Otherwise, joining of the two parts by laser welding would be impractical or limited to slow scan speeds. It is desired that the cycle time for assembly of parts be as short as possible.

Combined with its excellent flow when molten and its rapid crystallization upon cooling, poly(butylene terephthalate) (PBT) is highly suitable for injection molding into solid articles and parts thereof. PBT can be reinforced with glass fibers or mineral fillers and can be used in numerous applications, especially in the automotive and electrical industry, owing to its excellent electrical resistance, surface finish, and toughness. Additionally, products that incorporate PBT or a similar partially crystalline resin can provide thermal resistance in applications in which the products are subjected to short-term high heat exposure, particular electrical or automotive parts. For example, laser welding can be used for the assembly of housings for sensors or other electrical devices in an automotive vehicle.

A potential problem with welding materials based on partially crystalline resins such as PBT, however, is that such resins can also partially disperse or scatter incoming radiation. Consequently, the extent of the laser energy arriving at the joining interface can be diminished, thereby reducing the adhesion between the parts to be welded. In particular, a reduction in weld strength for a given amount of laser energy applied to the article to be welded can result in a substantial increase in laser welding assembly cycle time.

Another potential problem is that fillers, introduced into the weldable composition to increase the temperature resistance, are known to adversely affect properties of a weldable composition. Specifically, the presence of fillers such as glass fibers increase light scattering, especially when the layer thickness of the welded component parts is greater than 1.5 mm.

Internal scattering of the laser light in the transparent first (upper) part can bring about a rise in temperature, especially in thick walled parts. This can cause mobility and distortion in the join area which can lead to weld instabilities or part rupture. It is therefore beneficial to have high thermal resistance in the laser-light-transmissive part. The Vicat softening temperature, according to ISO 306 at 120° C./hr and a 50 N load, is widely used to provide an accurate measure of the thermal resistance of a thermoplastic composition.

In view of the above, it would be desirable to improve the transmission level of NIR laser light to a weldable interface through a weldable first part, especially when formed from a composition comprising filled partially crystalline resin, thereby facilitating the joining of the first part to a second part that absorbs rather than transmits the laser light. It is desirable that the weldable first part have excellent thermal properties for weld stability and that the welded first part possess advantageous mechanical properties for use in various applications, specifically electronic, automotive, or other applications requiring durability. It would also be beneficial for a composition for a weldable transmissive part to provide consistent laser transparency across a range of thicknesses and processing conditions in order to achieve consistent weld strengths.

One approach that has been investigated to increase the laser transparency of PBT-based compositions is to blend the PBT with an amorphous component such as polycarbonate or polyester carbonate. Such compositions are disclosed in DE 10230722 (U.S. Patent No. 20070129475), U.S. Pat. No. 7,396,428, U.S. Patent Publ. No. 20050165176, and U.S. Patent Publ. No. 2011/0256406.

An alternative approach to increase laser transparency is to speed up the rate of crystallization of the composition using a chemical nucleant. This can occur by chemical reaction between the nucleating agent and polymeric end groups of PBT polymer to produce ionic end groups that enhance the rate of crystallization. Such compositions are disclosed, for example, in U.S. Patent Publ. 2011/0288220 and U.S. Patent Publ. 2011/0306707. The addition of such chemical nucleants, however, can lower the molecular weight of a crystalline material and lead to unstable melt viscosity. Additionally, such chemical nucleants can substantially degrade many of the amorphous materials used in PBT blends such as polycarbonates and polyester carbonates, causing unstable melt viscosities and other undesirable defects such as splay and jetting (deformations due to turbulent flow).

### SUMMARY

In view of the above and the challenges involved, it is desired to achieve improved NIR transmission for laser-weldable thermoplastics, especially compositions comprising glass fibers or other fillers that provide heat resistance.

In one embodiment, a weldable composition made by a process comprising melt blending a combination of:

(a) from more than 10 to 70 weight percent of a partially crystalline thermoplastic polyester component selected from poly(butylene terephthalate), poly(ethylene terephthalate), poly(butylene terephthalate) copolymers, poly(ethylene terephthalate) copolymers, and combinations thereof;

(b) from 10 to 60 weight percent of amorphous polycarbonate having greater than 150 ppm to 10,000 ppm of Fries rearranged monomeric units;

(c) from 5 to 50 weight percent of a filler; and

(d) optionally from 0.01 to 10 weight percent of an antioxidant, mold release agent, colorant, stabilizer, or a combination thereof, wherein the melt blended composition has a polycarbonate aryl hydroxy end-group content of at least 300 ppm; and wherein the composition, when molded into an article having a 2.0 mm thickness, provides a near infrared transmission at 960 nanometers of greater than 45%.

In another embodiment, a weldable composition comprises a product made by a process of melt blending a combination of:

(a) from 20 to 60 weight percent of a partially crystalline polyester component selected from partially crystalline poly(butylene terephthalate), poly(ethylene terephthalate), poly(butylene terephthalate) copolymers, poly(ethylene terephthalate) copolymers, and combinations thereof;

(b) from 20 to 50 weight percent of an amorphous polycarbonate having 250 ppm to 10000 ppm of Fries rearranged units;

(c) from 10 to 40 weight percent glass filler; and

(d) optionally from 0.1 to 5 weight percent of an antioxidant, mold release agent, colorant, stabilizer, or a combination thereof, wherein the melt blended composition has a polycarbonate aryl hydroxy end-group content of greater than 350 ppm; and wherein the composition, when molded into an article having a 2.0 mm thickness, provides a near infrared transmission at 960 nanometers of greater than 50 percent and a Vicat softening temperature of at least 120° C.

In particular, an article having a 2.0 mm thickness and molded from the composition has a near infrared transmission at 960 nanometers of greater than 50, specifically greater than 55 percent.

In another embodiment, articles comprising the above compositions are disclosed herein.

A process is also disclosed for welding a laser-transmissive first part to a laser-absorbing second part of an article to be welded, wherein the first part comprises a composition as described above and the second part comprises a thermoplastic article comprising an NIR-absorbing agent, and wherein at least a portion of the surface of the first part is placed in physical contact with at least a portion of a surface of the second part, the process further comprising applying NIR-laser (electromagnetic) radiation to the first part such that radiation passes through the first part and is absorbed by the second part so that sufficient heat is generated to effectively weld the first part to the second part of the article.

Further disclosed is a laser welded, molded article comprising a first part comprising a first laser-transmissive part welded to a second laser-absorbing part, wherein the first part comprises a product as described above and a laser welded bond between the first (upper) part and the second (lower) part.

The above described and other features and advantages will become more apparent by reference to the following figures and detailed description.

### BRIEF DESCRIPTION OF DRAWING

FIG. 1 shows a 1H NMR spectrum of a polycarbonate (PC 172X) having a high content of Fries rearrangement and present in an example of a composition according to the present invention.

### DETAILED DESCRIPTION

Amorphous polymers such as polycarbonate are for the most part produced by one of two commercial processes. The interfacial polymerization process is the most widely used commercial processes for producing biphenol A polycarbonate. The production of bisphenol A polycarbonate involves the condensation of an aromatic dihydroxy compound such as bisphenol A (BPA) with phosgene (COCl₂). A base, typically caustic, is used to scavenge the hydrochloric acid generated. The condensation is catalyzed with either or both tertiary amine and/or a phase-transfer catalyst. The condensation is done in a two-phase media such as methylene chloride/water. The molecular weight, and therefore the melt viscosity of the resulting polymer, is controlled by the addition of a predetermined amount of chain stopper. Typically, monophenols such as phenol, p-cumylphenol, p-tert-butylphenol, and octylphenol have been used. The overall reaction is shown below in Equation (I):

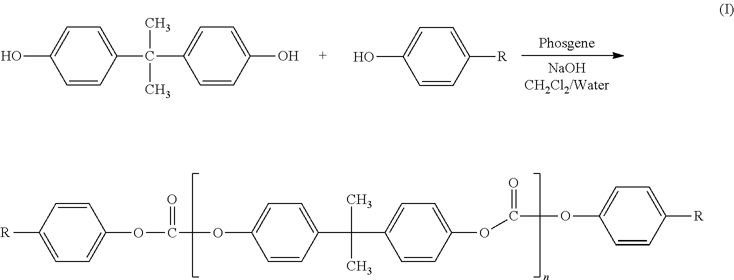

R, for example, is a C₃-C₈ alkyl group.

The other approach, the so-called melt polymerization (melt transesterification) process, is a solventless, thermal process. In the melt transesterification process for the preparation of bisphenol A polycarbonate, for example, an aromatic dihydroxy compound such as BPA is condensed with a diaryl carbonate such as diphenyl carbonate at elevated temperature and reduced pressure. The reaction is base catalyzed and is driven to high molecular weight by the removal of phenol under reduced pressure. The molecular weight of the resin is controlled by the amount of phenol that is removed. One of the major differences between melt prepared and interfacially prepared polycarbonate is that the melt prepared polycarbonate is typically not completely end-capped and some level of phenol-terminated polymer will usually be present. The melt process can be represented by Equation (II):

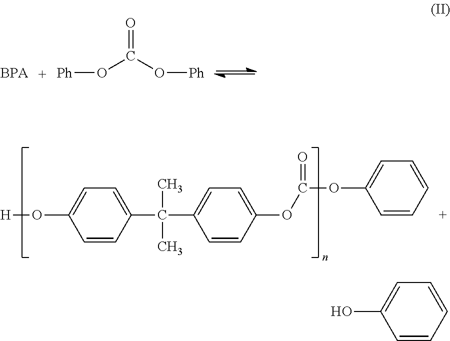

It is known that alkali metal compounds and alkaline earth compounds, when used as catalysts added to the monomer stage of the melt process, will not only generate the desired polycarbonate compound, but also other products via a rearrangement reaction known as the “Fries” rearrangement. The production of polycarbonates with a high degree “Fries” rearrangement has been described in the prior art U.S. Pat. No. 6,504,002. The rearranged polycarbonate compositions can be a mixture of linear, branched or extended Fries products.

Surprisingly, it has been found that the combination of crystalline or partially crystalline (semi-crystalline) polymers with certain amorphous polymers containing an aryl hydroxyl end-group content of greater than 300 ppm, in particular greater than 350 ppm, and more particularly greater than 500 ppm and/or a total Fries re-arranged unit content of greater than 150 ppm, in particular greater than 250 ppm, and more particularly greater than 300 ppm dramatically improves the near infra-red transparency (wavelengths of 800-1500 nm) of the polymer blend compared with those compositions in which an amorphous polymer produced by the interfacial process that has no more than 200 ppm of aryl hydroxyl end group content and no more than 150 ppm of total Fries rearranged units.

The compositions of the present invention advantageously provides increased transparency to NIR-laser light in molded, laser-transmitting parts for laser welding into articles, as compared to partially crystalline polymers alone, or polymer blends of partially crystalline with amorphous polymers having an aryl hydroxyl end-group content of lower than 300 ppm, in particular lower than 350 ppm, and more particularly lower than 500 ppm and/or a total Fries rearranged unit content of not more than 100 ppm, in particular not more than 150 ppm and more particularly no more than 250 ppm.

Accordingly, compositions of the present invention can unexpectedly facilitate the laser welding of articles at desirable weld speeds. Moreover, the present compositions can achieve high weld strength of welded articles without significantly sacrificing or impairing the desired physical properties of the articles. Furthermore, the weldable composition can contain substantial amounts of glass fiber or other filler. In particular, the disclosed compositions can exhibit high NIR transparency and good thermal properties, as measured at a near infrared transmission of 960 nanometers. A NIR laser-light transmission of greater than 45 percent and more specifically greater than 50 percent and a Vicat softening temperature of at least 120° C. can be obtained.

Compounds or polymers are described herein using standard nomenclature. The singular forms “a,” “an,” and “the” include plural referents unless the context clearly dictates otherwise. All references are incorporated herein by reference. The term “combination thereof” means that one or more of the listed components is present, optionally together with one or more like components not listed. Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations. The endpoints of all ranges reciting the same characteristic or component are independently combinable and inclusive of the recited endpoint.

As used herein, the term “melt polycarbonate” refers to a polycarbonate made by the transesterification of a diaryl carbonate with a dihydroxy aromatic compound.

“BPA” is herein defined as bisphenol A or 2,2-bis(4-hydroxyphenyl)propane.

As used herein the term “Fries rearrangement” refers to a branched structural unit of the product polycarbonate bearing a aryl carbonyl group adjacent to a hydroxyl, a carbonate, or an ether unit on the same aryl ring. The term “Fries product” refers to polymers having Fries rearranged units. Likewise, the terms “Fries reaction” and “Fries rearrangement” are used interchangeably herein.

The polycarbonates used in the present invention contain a relatively high level of aryl hydroxyl content, which is detectable when the polycarbonate is subjected to a 1H NMR analysis. The aryl hydroxyl content is greater than 300 ppm, in particular greater than 350 ppm, and more particularly greater than 500 ppm.

The polycarbonates used in the present invention contain relatively high levels of Fries rearrangement, which is detectable when the polycarbonate is subjected to a Fries product analysis. The content of the various Fries components in polycarbonates can be determined by NMR. NMR peaks corresponding to branched Fries structure, linear Fries structure, and acid Fries structure can be integrated to obtain the total Fries content. Quantification of Fries rearrangement content and the polycarbonate aryl hydroxy end-group content can be obtained based on the integral of the 1H NMR signal of the Fries components to the integral of the eight polycarbonate protons, as specifically described in the examples.

Alternatively, the Fries content can be measured by KOH methanolysis of a resin and can be reported as parts per million (ppm) as follows. First, 0.50 grams of polycarbonate is dissolved in 4.0 ml of THF (containing p-terphenyl as internal standard). Next, 3.0 mL of 18% KOH in methanol is added to this solution. The resulting mixture is stirred for two hours at room temperature. Next, 1.0 mL of acetic acid is added, and the mixture is stirred for 5 minutes. Potassium acetate by-product is allowed to crystallize over 1 hour. The solid is filtered off and the resulting filtrate is analyzed by high performance liquid chromatography (HPLC) using p-terphenyl as the internal standard.

Polycarbonates produced by a melt process or activated carbonate melt process such of those listed in U.S. Pat. Nos. 5,151,491 and 5,142,018 typically contain a significant concentration of Fries product. In the past, Fries rearrangement in a product has been considered undesirable, because it is believed that the generation of significant Fries rearrangement in a product can lead to polymer branching, resulting in relatively poor or uncontrollable melt behavior. In the present invention, however, the occurrence of such Fries arrangement has been found to be unexpectedly desirable.

Without wishing to be bound by theory, the Fries rearrangement is believed to effect the rate of crystallization of the composition, the slowing down of which may arise from improved miscibility or slowed de-mixing of partially crystalline component polymer with the amorphous component polymer which, in turn, reduces the scattering effect of the partially crystalline polymer.

As set forth above, the present composition can comprise from 10 to 70 wt. %, specifically at least 15 wt. %, more specifically 20 to 60 wt. % or 25 to 50 wt. %, most specifically 30 to 40 wt. % of a partially crystalline thermoplastic polyester component. The polyester component can comprise poly(butylene terephthalate), poly(ethylene terephthalate), poly(butylene terephthalate) copolymers, poly(ethylene terephthalate) copolymers, and combinations thereof. As used herein, a “partially crystalline” polymer characteristically comprises crystalline domains, in comparison to amorphous polymers.

The poly(butylene terephthalate), poly(ethylene terephthalate), poly(butylene terephthalate) copolymers, and poly(ethylene terephthalate) copolymers comprise repeating units of formula (1):

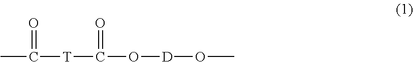

wherein T is a residue derived from a terephthalic acid or chemical equivalent thereof, and D is a residue derived from a diol such as ethylene glycol, butylene diol, specifically 1,4-butane diol, or chemical equivalent thereof. Chemical equivalents of diacids include dialkyl esters, e.g., dimethyl esters, diaryl esters, anhydrides, salts, acid chlorides, acid bromides, and the like. Chemical equivalents of diols include esters, for example, dialkylesters.

In addition to units derived from a terephthalic acid or chemical equivalent thereof, and ethylene glycol or butylene diol, specifically 1,4-butane diol, or chemical equivalent thereof, other T and/or D units can be present in the polyester, provided that the type or amount of such units do not significantly adversely affect the desired properties of the thermoplastic compositions. Specifically the alternative T and D units are present in an amount of not more than 30 mole %, specifically less than 20 mole %, more specifically less than 10 mole %, most specifically less than 5 mole % or repeat units.

Examples of alternative aromatic dicarboxylic acids include 1,4-naphthalenedicarboxylic acid, 1,5-naphthalenedicarboxylic acid, 2,6-naphthalenedicarboxylic acid, and combinations comprising at least one of the foregoing dicarboxylic acids. Exemplary cycloaliphatic dicarboxylic acids include norbornene dicarboxylic acids, 1,4-cyclohexanedicarboxylic acids, and the like. In a specific embodiment, T is derived from a combination of terephthalic acid and isophthalic acid wherein the weight ratio of terephthalic acid to isophthalic acid is 99:1 to 10:90, specifically 55:1 to 50:50.

Examples of alternative diols can include C₆₋₁₂ aromatic diols, for example, not limited to, resorcinol, hydroquinone, and pyrocatechol, as well as diols such as 1,5-naphthalene diol, 2,6-naphthalene diol, 1,4-naphthalene diol, 4,4′-dihydroxybiphenyl, bis(4-hydroxyphenyl) ether, bis(4-hydroxyphenyl) sulfone, and the like, and combinations comprising at least one of the foregoing aromatic diols.

Exemplary alternative C₂₋₁₂ aliphatic diols include, but are not limited to, straight chain, branched, or cycloaliphatic alkane diols such as propylene glycol, i.e., 1,2- and 1,3-propylene glycol, 2,2-dimethyl-1,3-propane diol, 2-ethyl-2-methyl-1,3-propane diol, 2,2,4,4-tetramethyl-cyclobutane diol, 1,3- and 1,5-pentane diol, dipropylene glycol, 2-methyl-1,5-pentane diol, 1,6-hexane diol, dimethanol decalin, dimethanol bicyclooctane, 1,4-cyclohexane dimethanol, including its cis- and trans-isomers, triethylene glycol, 1,10-decanediol; and combinations comprising at least of the foregoing diols.

The partially crystalline polyesters can have an intrinsic viscosity, as determined in phenol tetrachlorethane at 25° C., of 0.3 to 2 deciliters per gram, specifically 0.45 to 1.2 deciliters per gram. The polyesters can have a weight average molecular weight of 10,000 to 200,000 Daltons, specifically 20,000 to 150,000 Daltons as measured by gel permeation chromatography. In addition to the partially crystalline polyester component, the composition further comprises from 10 to 60 wt. %, specifically from greater than 15 to 55 wt. %, more specifically 20 to 50 wt. %, most specifically 25 to 45 wt. % of an amorphous thermoplastic polycarbonate that can be prepared by melt polymerization. The aryl hydroxyl end-group content of the amorphous thermoplastic polycarbonate is greater than 300 ppm, in particular greater than 350 ppm and more particularly greater than 500 ppm and/or a total Fries re-arranged unit content of greater than 100 ppm, in particular greater than 150 ppm and more particularly greater than 200 ppm.

In one embodiment, the weight ratio of partially crystalline to amorphous polycarbonate is 90:10 to 30:70, specifically 80:20 to 40:60, more specifically 70:30 to 50:50. The polycarbonate has a total Fries rearranged unit content of greater than 100 ppm, in particular greater than 150 ppm, more particularly greater than 250 ppm, and most particularly greater than 300 ppm, and/or an aryl hydroxyl end-group content of greater than 300 ppm, in particular greater than 350 ppm and more particularly greater than 500 ppm.

Polycarbonates comprise repeating structural carbonate units of formula (2):

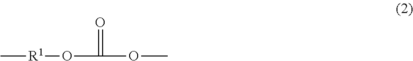

in which at least 60 percent of the total number of R¹ groups contain aromatic organic groups and the balance thereof are aliphatic, alicyclic, or aromatic groups. In an embodiment, each R¹ is a C₆₋₃₀ aromatic group, that is, contains at least one aromatic moiety. R¹ can be derived from a dihydroxy compound of the formula HO—R¹—OH, in particular a dihydroxy compound of formula (3):

HO-A¹-Y¹-A²-OH (3)

wherein each of A¹ and A² is a monocyclic divalent aromatic group and Y¹ is a single bond or a bridging group having one or more atoms that separate A¹ from A². In an exemplary embodiment, one atom separates A¹ from A². Specifically, each R¹ can be derived from a dihydroxy aromatic compound of formula (4)

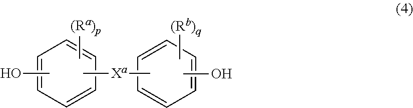

wherein R^{a} and R^{b} each represent a halogen or C₁₋₁₂ alkyl group and can be the same or different; and p and q are each independently integers of 0 to 4. Also in formula (4), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic bridging group can be disposed such that the C₆ arylene groups connected thereto are each connected to a common alkylidene carbon or to different carbons of the C₁₋₁₈ organic bridging group. In one embodiment, p and q is each 1, and R^{a} and R^{b} are each a C₁₋₃ alkyl group, specifically methyl, disposed meta to the hydroxy group on each arylene group.

In one embodiment, X^{a} is a substituted or unsubstituted C₃₋₁₈ cycloalkylidene, a C₁₋₂₅ alkylidene of formula —C(R^{c})(R^{d})— wherein R^{e} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene.

Other useful aromatic dihydroxy compounds that can be present in relatively minor amounts are of the formula HO—R¹—OH and include compounds of formula (5)

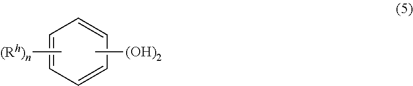

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, and the like, as well as combinations comprising at least one of the foregoing dihydroxy compounds.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

The polycarbonates can have a weight average molecular weight of 10,000 to 200,000 Daltons, specifically 20,000 to 150,000 Daltons as measured by gel permeation chromatography (GPC), using a cross-linked styrene-divinylbenzene column and calibrated to polycarbonate references. GPC samples are prepared at a concentration of 1 mg/ml, and are eluted at a flow rate of 1.5 ml/min.

As discussed above, polycarbonates can be manufactured by either an interfacial process of polymerization or a melt process polymerization as is known in the art with appropriate adjustment, as discussed below, to obtain the desired Fries rearrangement. A higher Fries content is more characteristic of melt process polymerization. Compared to interfacial polymerization, the melt process obviates the need for phosgene during polymerization or a solvent such as methylene chloride. The melt process, however, requires high temperatures and relatively long reaction times. The melt process can also involve the use of complex processing equipment capable of operation at high temperature and low pressure, capable of efficient agitation of the highly viscous polymer melt during the relatively long reaction times required to achieve the desired molecular weight. Specifically, the melt process involves a polycondensation reaction of an aromatic dihydroxy compound with a carbonic diester, which can be carried out under conditions conventionally known and commonly employed. In a conventional method, a first stage reaction of the aromatic dihydroxy compound with carbonic diester (for example, diphenyl carbonate) can be carried out under ordinary pressure at a temperature of 80 to 250° C., specifically 100 to 230° C., more specifically 120 to 190° C., for 0.1 to 5 hours, specifically 0.25 to 4 hours, for example. Subsequently, the system can be evacuated and the reaction temperature elevated to carry out the reaction of the aromatic dihydroxy compound with carbonic diester at reduced pressure of less than 1 mm Hg at a temperature of 240 to 320° C.

During preparation of the polycarbonate, the Fries rearrangement denotes the presence of a repeating unit in a polycarbonate having the following formula:

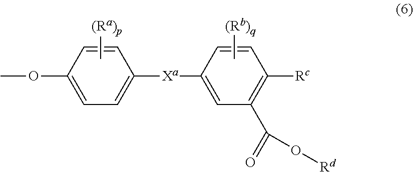

Wherein R^{a}, R^{b}, p, q, and X^{a} are defined as above. R^{c} can be a hydroxyl group or a carbonate or ether. A polymer chain can form via the carbonate or ether group. The R^{d} can be hydrogen or a substituted aryl group. A polymer chain can form via the substituted aryl group. For example, the following rearrangements (linear Fries, branched/ether Fries, and acid Fries) can occur:

### Linear Fries

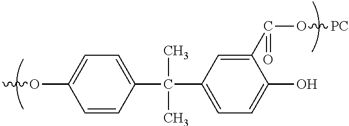

### Branched/Ether Fries

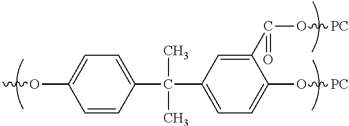

### Acid Fries

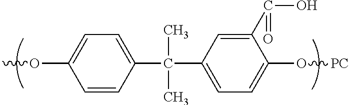

The total amount of branched Fries rearrangement can be adjusted during melt polymerization by varying the temperatures and/or reaction times. This is because by-products formed at high temperature include Fries rearrangement of carbonate units along the growing polymer chains. The Fries rearrangement of carbonate units along the growing polymer chains can also be measured to ensure that the process adjustments provide the desired amount of Fries rearrangement. A Fries arranged polycarbonate or polyester-carbonate copolymer having a specified amount of Fries rearrangement, as analytically determined, is also commercially available from various suppliers, including SABIC's Innovative Plastics business under the Lexan® trademark in various resin grades according to additives present, melt flow or other properties, and ratings.

The present composition can further optionally comprise other amorphous polycarbonates which are not restricted to polymers produced by melt transesterification and can include linear or branched polycarbonate homo-polymers, copolymers, and polyester-carbonate copolymers for example.

The thermoplastic compositions further comprise a filler in an amount from 5 to 50, specifically 10 to 40 wt. % of the total weight of the composition. Such fillers include fibrous reinforcing materials, for example, inorganic fibers (e.g., glass, silica, alumina, silica-alumina, aluminum silicate, zirconia, silicon carbide, or the like), inorganic whiskers (e.g., silicon carbide, alumina, or the like), organic fibers (e.g., aliphatic or aromatic polyamide, aromatic polyester, fluorine-containing resins, acrylic resin such as a polyacrylonitrile, rayon or the like), plate-like reinforcing materials (e.g., talc, mica, glass, and the like), particulate reinforcing materials (e.g., glass beads, glass powder, milled fiber (e.g., a milled glass fiber), or, which can be in the form of a plate, column, or fiber. The average diameter of the fibrous reinforcing material (as introduced into a blend) can be, for example, 1 to 50 micrometers, specifically 3 to 30 μm micrometers, more specifically 8 to 15 micrometers and the average length of the fibrous reinforcing material can be, for example, 100 micrometers to 15 mm, specifically 1 mm to 10 mm, and more specifically 2 mm to 5 mm. Moreover, the average particle size of the plate-like or particulate reinforcing material may be, for example, 0.1 to 100 μm and specifically 0.1 to 50 micrometers (e.g., 0.1 to 10 micrometers).

In a specific embodiment, the reinforcing filler is a glass or glassy filler, specifically a glass fiber, a glass flake, and a glass bead, talc, or mica. In particular, the reinforcing filler is glass fibers, particularly, a chopped strand product. In one embodiment, the glass fiber has an average diameter of 2 to 12 mm in length and 8 to 15 micrometer in diameter. The glass fiber can be coated with a silane, epoxy silane, or other surface-treating agent (solid loss on Ignition of 0.1-2.5%).

In the final composition, because of breakage of the glass fibers during mixing and melt blending, the average length for chopped glass fibers can be about 0.1 to 10 mm, specifically, 2 to 5 mm.

The thermoplastic composition can include various other additives ordinarily incorporated with compositions of this type, with the proviso that the additives are selected so as not to significantly adversely affect the desired properties of the composition. Combinations of additives can be used. Exemplary additives include an antioxidant, thermal stabilizer, light stabilizer, ultraviolet light absorbing additive, quencher, plasticizer, mold release agent, antistatic agent, radiation stabilizer, mold release agent, or a combination thereof. Each of the foregoing additives, when present, is used in amounts typical for thermoplastic blends, for example, 0.01 to 15 wt. % of the total weight of the blend, specifically 0.1 to 10 wt. % of the total weight of the blend, based on the total weight of the composition, and fillers.

In one embodiment, the composition comprises from 0.01 to 5 wt. % of a combination of an antioxidant, mold release agent, colorant, and/or stabilizer, based on the total weight of the composition.

Exemplary antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants can be used in amounts of 0.0001 to 1 wt. %, based on the total weight of the composition.

Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers can be used in amounts of 0.0001 to 1 wt. %, based on the total weight of the composition.

Mold release agents include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate, the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; combinations of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials can be used in amounts of 0.001 to 1 wt. %, specifically 0.01 to 0.75 wt. %, and more specifically 0.1 to 0.5 wt. %, based on the total weight of the composition.

Optionally, the composition of the present invention further includes a colorant, specifically either one or more colorants that do not absorb substantially in the NIR (800 to 1500 nm) and from which a colored laser transmitting article can be molded. The composition of the present invention can optionally be used for the laser-absorbing part except that one or more laser absorbing colorants, for example, carbon black, organic compounds such as perylenes, or nanoscaled inorganic compounds such as metal oxides, mixed metal oxides or metal-borides can be added.

Suitable examples of laser transparent colored compositions including black can be manufactured through a selection and combination of colorants generally available in the art including but not limited to anthraquinone, perinone, quinoline, perylene, methane, coumarin, phthalimide, isoindoline, quinacridone, azomethine dyes, and combinations comprising one or more of the aforesaid dye classes.

The composition can have a Vicat softening temperature of at least 120° C., more specifically about 130 to 200° C., most specifically 140° C. to 180° C. according to ISO 306 at 120° C./hr and 50 N load.

The present composition can also be characterized as providing an article having any one or more or all of the following properties with respect to NIR laser light transmission. An article having a 2.0 mm thickness and molded (at a mold temperatures of 70° C.) from the composition can have a near infrared transmission at 960 nanometers of greater than 48 percent, specifically greater than 52 percent to 85 percent, more specifically at least 55 percent. An article having a 2.0 mm thickness and molded (averaged transmission at mold temperatures between 70° C. and at 90° C.) from the composition can have a near infrared transmission at 960 nanometers of greater than 45 percent, specifically greater than 48 to 85 percent, more specifically at least 50 percent, most specifically at least 55 percent. An article having a 2.0 mm thickness and molded (at a mold temperatures of 70° C.) from the composition can have a near infrared transmission at 1065 nanometers of greater than 50 percent, specifically greater than 52 to 85 percent, more specifically at least 55 percent.

An article having a 2.0 mm thickness and molded (averaged transmission at mold temperatures between 70° C. and 90° C.) from the composition has a near infrared transmission at 960 nanometers, of at least 5%, specifically at least 10%, more specifically at least 15% greater than the same composition with the polycarbonate replaced by a comparable polycarbonate having a total Fries rearrangement of less than 150 ppm.

In a specific embodiment, a thermoplastic composition comprises a product of melt blending a combination of:

(a) from more than 20 to 60 wt. % of a partially crystalline polyester component selected from crystalline poly(butylene terephthalate), poly(ethylene terephthalate), poly(butylene terephthalate) copolymers, poly(ethylene terephthalate) copolymers, and combinations thereof;

(b) from 20 to 50 wt. % of an amorphous polycarbonate having a Fries arrangement of 150 ppm to 10000 ppm;

(c) optionally from 0.1 to 5 wt. % of an antioxidant, mold release agent, colorant, stabilizer, or a combination thereof; wherein an article having a 2 mm thickness and molded from the composition has a near infrared transmission at 960 nanometers of greater than 45 percent, specifically greater than 50 percent, and more specifically greater than 55 percent.

The thermoplastic composition can be manufactured by methods generally available in the art. For example, one method of manufacturing a thermoplastic composition comprises melt blending the components of the composition. More particularly, the powdered thermoplastic polymer components and other optional additives (including stabilizer packages, e.g., antioxidants, heat stabilizers, mold release agents, and the like) are first blended, in a HENSCHEL-Mixer® high speed mixer. Other low shear processes such as hand mixing can also accomplish this blending. The blend is then fed into the throat of an extruder via a hopper. Alternatively, one or more of the components can be incorporated into the composition by feeding directly into the extruder at the throat and/or downstream through a sidestuffer. Alternatively, any desired additives can also be compounded into a masterbatch, and combined with the remaining polymeric components at any point in the process. The extruder is generally operated at a temperature higher than that necessary to cause the composition to flow. The extrudate is immediately quenched in a water batch and pelletized. Such pellets can be used for subsequent molding, shaping, or forming. In specific embodiments, a method of manufacturing a thermoplastic composition comprises melting any of the above-described compositions to form the laser-weldable composition.

Shaped, formed, or molded articles comprising the compositions are also provided. In one embodiment, an article is formed by extruding, casting, blow molding, or injection molding a melt of the thermoplastic composition. The article can be in the form of a film or sheet.

In another aspect of the invention, parts can be assembled into an article by laser welding. A process for welding a first part comprising the above compositions to a second part comprises physically contacting at least a portion of a surface of the first part with at least a portion of a surface of the second part, applying NIR laser radiation to and through the first part, which provides improved transmission, wherein after the radiation passes through the first part, the radiation is absorbed by the thermoplastic composition of the second part and sufficient heat is generated to weld the first part to the second part, resulting in a welded article.

The second thermoplastic part of the article can comprise a wide variety of thermoplastic polymer compositions that have been rendered laser absorbing by means known to those of skill in the art including the use of additives and/or colorants such as but not limited to carbon black. Exemplary polymer compositions can include but are not limited to, olefinic polymers, including polyethylene and its copolymers and terpolymers, polybutylene and its copolymers and terpolymers, polypropylene and its copolymers and terpolymers; alpha-olefin polymers, including linear or substantially linear interpolymers of ethylene and at least one alpha-olefin and atactic poly(alpha-olefins); rubbery block copolymers; polyamides; polyimides; polyesters such as poly(arylates), poly(ethylene terephthalate) and poly(butylene terephthalate); vinylic polymers such as polyvinyl chloride and polyvinyl esters such as polyvinyl acetate; acrylic homopolymers, copolymers and terpolymers; epoxies; polycarbonates, polyester-polycarbonates; polystyrene; poly(arylene ethers), including poly(phenylene ether); polyurethanes; phenoxy resins; polysulfones; polyethers; acetal resins; polyoxyethylenes; and combinations thereof. More particularly, the polymers are selected from the group consisting of polyethylene, ethylene copolymers, polypropylene, propylene copolymers, polyesters, polycarbonates, polyester-polycarbonates, polyamides, poly(arylene ether)s, and combinations thereof. In a specific embodiment, the second article comprises an olefinic polymer, polyamide, polyimide, polystyrene, polyarylene ether, polyurethane, phenoxy resin, polysulfone, polyether, acetal resin, polyester, vinylic polymer, acrylic, epoxy, polycarbonate, polyester-polycarbonate, styrene-acrylonitrile copolymers, or a combinations thereof. More specifically, the second article comprises a polycarbonate homopolymer or copolymer, polyester homopolymer or copolymer, e.g., a poly(carbonate-ester) and combinations thereof.

In one embodiment the second part of the article comprises a glass-filled crystalline or partially crystalline composition that has been rendered laser absorbing. Compositions and methods for rendering such composition laser absorbing are known to those of skill in the art.

In one embodiment, the second part comprises a glass-filled combination of a partially crystalline composition and an amorphous thermoplastic poly(ester) copolymer, poly(ester-carbonate), or combination thereof that has been rendered laser absorbing.

The thermoplastic composition of the laser-absorbing second part of the article can further comprise an effective amount of a near-infrared absorbing material (a material absorbing radiation wavelengths from 800 to 1400 nanometers) that is also not highly absorbing to visible light (radiation wavelengths from 350 nanometers to 800 nanometers). In particular the near-infrared absorbing material can be selected from organic dyes including polycyclic organic compounds such as perylenes, nanoscaled compounds, metal complexes including metal oxides, mixed metal oxides, complex oxides, metal-sulphides, metal-borides, metal-phosphates, metal-carbonates, metal-sulphates, metal-nitrides, lanthanum hexaboride, cesium tungsten oxide, indium tin oxide, antimony tin oxide, indium zinc oxide, and combinations thereof. In one embodiment, the near-infrared material has an average particle size of 1 to 200 nanometers. Depending on the particular NIR absorbing material used, the NIR absorbing material can be present in the thermoplastic composition of the second article in an amount from 0.00001 to 5 wt. % of the composition. Effective amounts for NIR absorption in welding are readily determined by one of ordinary skill in the art without undue experimentation. Lanthanum hexaboride and cesium tungsten oxide, for example, can be present in the composition in an amount from 0.00001 to 1 wt. %, still more specifically 0.00005 to 0.1 wt. %, and most specifically 0.0001 to 0.01 wt. %, based on total weight of the laser-weldable composition for the absorbing part of the article to be welded.

Also disclosed are laser-welded articles comprising the inventive thermoplastic compositions as described above in a first component, laser-welded to a second component comprising a second thermoplastic composition as described above.

The compositions and methods are further illustrated by the following Examples, which do not limit claims. Unless indicated otherwise molecular weights are weight average molecular weights.

### Examples

### Materials

The materials shown in Table 1 were used in the Examples below.

TABLE 1

| COMPONENT | CHEMICAL DESCRIPTION | SOURCE |
|---|---|---|
| PBT 195 | Poly(1,4-butylene terephthalate), (M_{w} = 66,000 g/mol, | SABIC's |
| | using polystyrene standards) | Innovative Plastics |
| | | Business |
| PBT 315 | Poly(1,4-butylene terephthalate), (M_{w} = 115,000 g/mol, | SABIC's |
| | using polystyrene standards) | Innovative Plastics |
| | | Business |
| PC 175 | Bisphenol A polycarbonate homopolymer (M_{w} = | LEXAN ®, |
| | 22,000 g/mol), prepared by interfacial process, | SABIC's |
| | amorphous. The amount of Fries rearrangement is | Innovative Plastics |
| | under 100 ppm. | Business |
| PC 172L | Bisphenol A polycarbonate homopolymer (M_{w} = | LEXAN ®, |
| | 23,000 g/mol), prepared by melt process, amorphous. | SABIC's |
| | The amount of Fries rearrangement is over 150 ppm | Innovative Plastics |
| | (about 350 ppm). | Business |
| PC 172X | S1220-62, a bisphenol A polycarbonate homopolymer | LEXAN ®, |
| | (M_{w} = 23,000 g/mol), prepared by melt process, | SABIC's |
| | amorphous. The amount of Fries arrangement is high | Innovative Plastics |
| | (about 5400 ppm). | Business |
| PC 198 | THPE-branched polycarbonate. (M_{w} = 34,000 g/mol). | LEXAN ®, |
| | The amount of Fries rearrangement is under 100 ppm. | SABIC's |
| | THPE is 1,1,1-Tris(4-hydroxyphenyl)ethane. | Innovative Plastics |
| | | Business |
| AO1010 | Pentaerythritol tetrakis(3,5-di-tert-butyl-4- | IRGANOX 1010, |
| | hydroxyhydrocinnamate) | Ciba Specialty |
| | | Chemicals |
| Glass fiber | SiO₂ - fibrous glass (10 mm length, 13 micrometer | Nippon Electric |
| | diameter) | Glass T120 |
| MZP | Monozinc phosphate-2-hydrate | Chemische Fabriek |
| PETS | Pentaerythritol tetrastearate | Lonza, Inc. |

Polycarbonate molecular weights are based on GPC measurements using a polystyrene standard and calibrated and expressed in polycarbonate units.

### Test Methods

The samples are prepared in deuterated chloroform 99% grade, containing 0.03% TMS as internal standard for chemical shift calibration. Approximately 100 mg of the sample is weighed into a sample vial and 0.8 ml CDCl₃ is added. The following instrument settings were used:

TABLE 2

| NMR Variable | Setting |
|---|---|
| Frequency | 300 MHz or 400 MHz |
| Pulse width | 90° |
| Time domain size | 32K data points |
| Recycle delay | 8 sec |
| Sweep width | 15 ppm (6000 Hz for 400 MHz) |
| Center of the spectral window | 6 ppm (transmitter frequency) |
| Number of scans | 256 |
| rf pulse sequence | appropriate pulse sequence with a single |
| | pulse and acquisition |
| Sample spinning speed | 20 Hz |
| Receiver gain | Automatic receiver gain adjustment. In |
| | case of excessive tailing near the huge |
| | polycarbonate signals, the receiver gain |
| | can be reduced by a factor of two. |

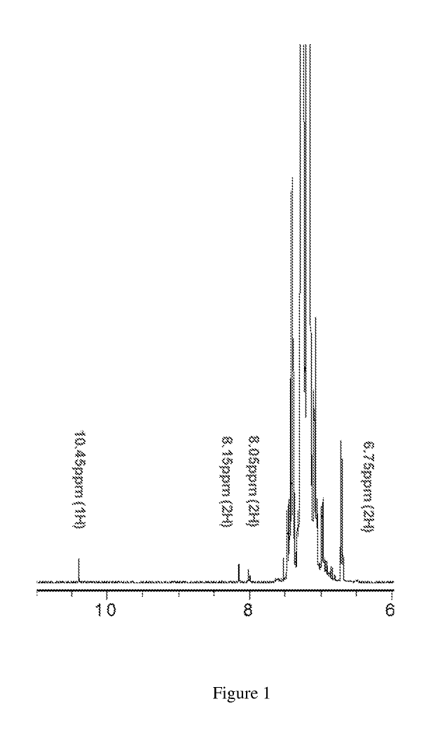

Quantification of Fries rearrangement content and polycarbonate aryl hydroxy end-group content can be measured by relating the integral of the 1H NMR signal of the Fries components to the integral of the eight polycarbonate protons. Specifically, approximately 100 mg of the resin or blended material was added to 0.8 mL of CDCl₃, deuterated chloroform, 99% grade, containing 0.03% tetra methyl silane (TMS) as internal standard for chemical shift calibration. In the case of extruded blend material the sample was shaken for 48 to 72 hours. The data was acquired on a 400 MHz NMR from 256 scans. Standard manipulations of the free induced decay signal by Fourier transformation, phase and baseline correction were carried out to obtain the spectrum with TMS as internal standard for chemical shift calibration. Specifically, the integrals of the signals at 10.45 ppm (one proton), 8.15 ppm (two protons) and 8.05 ppm (two proton) were proportioned to the integral of the eight polycarbonate protons between 6.4 to 7.5 ppm and used to calculate the total Fries content. The signal at 6.7 ppm (two protons) was proportioned to the integral of the eight polycarbonate protons between 6.8 ppm to 7.5 ppm and used to calculate the polycarbonate-hydroxyl content. Using this NMR measurement, FIG. 1 shows a 1H NMR spectrum of PC 172X polycarbonate.

Poly(butylene terephthalate) (“PBT”) and polycarbonate (“PC”) were melt blended in the presence of processing aids, glass fibers and acid quenchers in an extruder. Molten polymer strands were cooled in a water bath and pelletized after which 60 mm×60 mm plaques of two different thickness (1.6 and 2.0 mm, respectively) were molded.

The near infrared (NIR) percentage transmission data was measured on 1.6 mm and 2 mm thick parts molded at 70° C. and 90° and collected on a Perkin-Elmer Lambda® 950 spectrophotometer at 960 nm and 1065 nm. Two measurements were taken per molded part, one measurement at the base of the part and one measurement close to the gate and the average reported. Vicat softening temperature, heat deflection temperature, and MVR were also determined on molded samples and pellets, respectively, in accordance with ISO methods, as follows.

TABLE 3

| Test | Description |
|---|---|
| Melt Volume Rate | Melt Volume Rate (MVR) was determined at |
| (MVR) | 250° C. using a 2.16 kilogram weight, at |
| | 5 and 15 minutes, respectively, over 10 minutes in |
| | accordance with ISO 1133. |
| Vicat Softening | Vicat Softening temperature was measured |
| Temperature | according to ISO 306 at 120° C./hr and 50N load. |
| Heat Deflection | HDT was measured at 0.45 MPa or 1.8 MPa on the |
| Temperature (HDT) | flat side of a 4-mm thick bar according to ISO 75Af. |

Table 4 shows various PC/PBT blends in combination with 20% glass fibers. Specifically, the compositions of Comparative Examples 1 and 2 contained a polycarbonate having relatively low Fries rearrangement, prepared by interfacial polymerization (PC 175).

TABLE 4

| | | | C. Ex. 1 | C. Ex. 2 | Ex. 1 | Ex. 2 | Ex. 3 |
|---|---|---|---|---|---|---|---|
| Item Description | | Unit | | | | | |
| PC 172L | | % | — | 10 | 20 | 30 | 36.69 |
| PC 175 | | % | 36.99 | 26.69 | 19.69 | 9.69 | — |
| PBT 195, milled | | % | 40 | 40 | 40 | 40 | 40 |
| Mono zinc phosphate | | % | 0.05 | 0.05 | 0.05 | 0.05 | 0.05 |
| Glass fiber | | % | 20 | 20 | 20 | 20 | 20 |
| Antioxidant 1010 | | % | 0.06 | 0.06 | 0.06 | 0.06 | 0.06 |
| PETS (>90% esterified) | | % | 0.2 | 0.2 | 0.2 | 0.2 | 0.2 |
| Total | | | 100 | 100 | 100 | 100 | 100 |
| Property | | Thickness | | | | | |
| Transmission (molded at | | 1.6 mm | 71 | 71 | 78 | 81 | 82 |
| 70° C.) at 960 nm | | | | | | | |
| Reflection (70° C.) at 960 nm | | 1.6 mm | 15 | 18 | 12 | 11 | 10 |
| Transmission (molded at | | 1.6 mm | 62 | 65 | 73 | 76 | 80 |
| 90° C.) at 960 nm | | | | | | | |
| Reflection (90° C.) at 960 nm | | 1.6 mm | 23 | 23 | 16 | 14 | 12 |
| Average transmission | | 1.6 mm | 67 | 68 | 76 | 78 | 81 |
| at 960 nm | | | | | | | |
| Average transmission | | 1.6 mm | --73 | 72 | 79 | 81 | 82 |
| at 1065 nm | | | | | | | |
| Average reflection | | 1.6 mm | 19 | 20 | 14 | 12 | 11 |
| At 960 nm | | | | | | | |
| Transmission (molded at | | 2 mm | 44 | 43 | 53 | 57 | 62 |
| 70° C.) at 960 nm | | | | | | | |
| Reflection (70° C.) at 960 nm | | 2 mm | 39 | 42 | 33 | 27 | 21 |
| Transmission (molded at | | 2 mm | 38 | 40 | 45 | 48 | 56 |
| 90° C.) at 960 nm | | | | | | | |
| Reflection (90° C.) at 960 nm | | 2 mm | 46 | 46 | 41 | 38 | 27 |
| Average transmission | | 2 mm | 41 | 41 | 49 | 53 | 59 |
| at 960 nm | | | | | | | |
| Average transmission | | 2 mm | --47 | 46 | 54 | 58 | 63 |
| at 1065 nm | | | | | | | |
| Average reflection | | 2 mm | 42 | 44 | 37 | 32 | 24 |
| At 960 nm | | | | | | | |
| Property | | Unit | | | | | |
| Total Fries Rearrangement | | ppm | <100 | <100 | 161 | 198 | 222 |
| PC aryl OH end-group content | | ppm | 139 | 277 | 427 | 628 | 745 |
| HDT | 0.45 MPa | ° C. | 149 | 152 | 145 | 138 | 149 |
| | 1.8 MPa | ° C. | 114 | 113 | 107 | 106 | 107 |
| MVR | 2.16 kg/250° C. | — | 14 | 14 | 15 | 16 | 15 |
| | 300 sec | | | | | | |
| | 2.16 kg/250° C. | — | 15 | 16 | 15 | 16 | 16 |
| | 900 sec | | | | | | |
| Vicat | 50N/120° C./h | ° C. | 146 | 148 | 145 | 146 | 147 |

The experimental results in Table 4 illustrate that increasing the relative loading of high Fries polycarbonate (PC 172L), a polycarbonate having relatively higher Fries rearrangement (prepared by a melt polymerization method) while lowering the relative loading of the interfacial polycarbonate (PC 9175) increases the NIR transmission through molded parts having a 2 mm wall thickness. The increase was appreciable when the two are in a 1:1 ratio, with an increase over 15% when all the interfacial polycarbonate is replaced by melt polycarbonate having a total Fries content of greater than 150 ppm. The MVR and Vicat temperature was not significantly affected by the use of the higher Fries polycarbonate, varying by only a point or two.

Table 5 shows PC/PBT blend combinations in the presence of 30% glass fibers. The compositions compare linear (C.Ex. 3) and branched polycarbonate (C.Ex. 4) having total Fries rearranged units less than 100 ppm with PC 172L polycarbonate and PC 172X, having total Fries rearranged units of 350 and 5400 ppm, respectively.

TABLE 5

| | | C. Ex. 3 | C. x. 4 | Ex. 4 | Ex. 5 |
|---|---|---|---|---|---|
| Item Description | Unit | | | | |
| PBT 195, milled | % | 34.59 | 34.59 | 34.59 | 34.59 |
| PETS (>90% | % | 0.3 | 0.3 | 0.3 | 0.3 |
| esterified) | | | | | |
| Antioxidant 1010 | % | 0.06 | 0.06 | 0.06 | 0.06 |
| Mono zinc phosphate | % | 0.05 | 0.05 | 0.05 | 0.05 |
| Glass fiber | % | 30 | 30 | 30 | 30 |
| PC 175 | % | 35 | | | |
| PC 172L | % | | | 35 | |
| PC 172X | % | | | | 35 |
| PC 198 | % | | 35 | | |
| Total | % | 100 | 100 | 100 | 100 |
| Property | Thickness | | | | |
| Transmission at | 1.6 mm | 70.5 | 59.7 | 78.6 | 79.2 |
| 960 nm (molded at | | | | | |
| 70° C.) | | | | | |
| Transmission at | 1.6 mm | 73.5 | 64.1 | 79.8 | 80.1 |
| 1065 nm (molded at | | | | | |
| 70° C.) | | | | | |
| Reflection at 960 nm | 1.6 mm | 17.8 | 64.1 | 11.1 | 10.5 |
| (molded at 70° C.) | | | | | |
| Transmission at | 2.0 mm | 42.3 | 41.2 | 62.7 | 79.0 |
| 960 nm (molded at | | | | | |
| 70° C.) | | | | | |
| Transmission at | 2.0 mm | 46.6 | 45.4 | 67.8 | 80.4 |
| 1065 nm (molded at | | | | | |
| 70° C.) | | | | | |
| Reflection at 70° C.) | 2.0 mm | 40.3 | 45.4 | 22.4 | 11.5 |
| Property | Unit | | | | |
| Total Fries | ppm | <100 | <100 | 190 | 3200 |
| PC-OH end-group | ppm | 156 | 103 | 827 | 1036 |
| content | | | | | |

Surprisingly the use of the branched polycarbonate PC 198 (obtained from the interfacial process) dramatically decreased the NIR transmission at 1.6 mm thick parts, while at 2 mm thickness the transmission values were similar to linear polycarbonate, PC 175. Both these polymers contain low Fries rearranged units and low aryl PC—OH end-group content. On the other hand, as with the 20% glass filled compositions, the addition of polycarbonate having the requisite Fries content, as produced by melt transesterification, increased the NIR transparency. The increase is augmented when PC 175 having a total Fries content of less than 100 ppm is replaced by PC 172X with a total Fries content of 5400 ppm.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1-13. (canceled)

14. A process for welding a laser-transmissive first part to a laser-absorbing second part of an article, wherein
the first part comprises a composition made by a process comprising melt blending:
(a) from 10 to 70 weight percent of a partially crystalline polyester component selected from poly(butylene terephthalate), poly(ethylene terephthalate), poly(butylene terephthalate) copolymers, poly(ethylene terephthalate) copolymers, and combinations thereof;
(b) from 10 to 60 weight percent of an amorphous polycarbonate having a Fries rearrangement of greater than 150 to 10,000 ppm;
(c) from 5 to 50 weight percent of a filler; and
(d) optionally, from 0.01 to 10 wt. % of an antioxidant, mold release agent, stabilizer, or a combination thereof;
wherein the melt blended composition has a polycarbonate aryl hydroxy end-group content of at least 300 ppm;
wherein the melt blended composition excludes colorant; and
wherein the composition, when molded into an article having a 2.0 mm thickness, provides a near infrared transmission at 960 nanometers of greater than 45%; and
the second part comprises a thermoplastic composition comprising an NIR-absorbing agent, and where at least a portion of a surface of the first part is placed in physical contact with at least a portion of a surface of the second part to form a welding join area,
the process further comprising applying NIR-laser radiation to the first part such that the radiation substantially passes through the first part and is absorbed by the second part so that sufficient heat is generated to effectively weld the first part to the second part of the article.

15. The process of claim 14, wherein the second article comprises a polymer selected from the group consisting of polycarbonate, polyester, polycarbonate copolymers, polyester copolymers, and combinations thereof.

16. The process of claim 14, wherein the second article comprises a NIR absorbing material selected from the group consisting of organic dyes, metal oxides, mixed metal oxides, complex oxides, metal-sulphides, metal-borides, metal-phosphates, metal-carbonates, metal-sulphates, metal-nitrides, lanthanum hexaboride, cesium tungsten oxide, indium tin oxide, antimony tin oxide, indium zinc oxide, and combinations thereof, wherein the NIR absorbing material is present in the thermoplastic composition of the second part in an effective amount from 0.00001 to 5 wt. %, based on total weight of the laser-weldable composition.

17. A laser welded, molded article comprising a first laser-transmissive part welded to a second laser-absorbing part, wherein the first part comprises a product made by a process comprising melt blending:
(a) from 10 to 70 weight percent of a partially crystalline thermoplastic polyester component selected from poly(butylene terephthalate), poly(ethylene terephthalate), poly(butylene terephthalate) copolymers, poly(ethylene terephthalate) copolymers, and combinations thereof;
(b) from 10 to 60 weight percent of an amorphous polycarbonate having a Fries rearrangement of greater than 150 to 10,000 ppm;
(c) from 5 to 50 weight percent of a filler; and
(d) optionally, from 0.01 to 10 wt. % of an antioxidant, mold release agent, stabilizer, or a combination thereof;
wherein the product made by the process excludes colorant;
wherein the melt blended composition has a polycarbonate aryl hydroxy end-group content of at least 300 ppm; and wherein the composition, when molded into an article having a 2.0 mm thickness, provides a near infrared transmission at 960 nanometers of greater than 45%.

18. The process of claim 14 wherein the composition, when molded into an article having a 2.0 mm thickness, provides a near infrared transmission at 960 nanometers, of greater than 48%, based on an average of samples molded at 70° C. and 90° C.

19. The process of claim 14 wherein an article having a 2.0 mm thickness and molded from the composition has a near infrared transmission at 960 nanometers at least 5% greater than the same composition with the polycarbonate replaced by an comparable polycarbonate having a Fries rearrangement of less than 150 ppm.

20. The process of claim 14 wherein the composition has a Vicat softening temperature of 120 to 180° C. according to ISO 306 at 120° C./hr and 50 N load.

21. The process of claim 14 wherein the partially crystalline thermoplastic is poly(butylene terephthalate).

22. The process of claim 14 wherein the amorphous thermoplastic polymer comprises a bisphenol A polycarbonate.

23. The process of claim 14 wherein the Fries content is at least 250 ppm.

24. The process of claim 14 wherein the polycarbonate is made by a process of melt polycondensation.

25. The process of claim 14 wherein the filler is glass fiber having an average diameter of 3 to 30 micrometers and an average length of 0.1 to 15 mm before said melt blending.

26. The process of claim 14 wherein the composition comprises a product made by a process of melt blending a combination of:
(a) from more than 20 to 60 weight percent of a partially crystalline polyester component selected from crystalline poly(butylene terephthalate), poly(ethylene terephthalate), poly(butylene terephthalate) copolymers, poly(ethylene terephthalate) copolymers, and combinations thereof;
(b) from 20 to 50 weight percent of an amorphous polycarbonate having a Fries rearrangement of greater than 250 to 10,000 ppm;
(c) from 10 to 40 weight percent glass filler; and
(d) optionally from 0.1 to 5 weight percent of an antioxidant, mold release agent, stabilizer, or a combination thereof;
wherein the melt blended composition has a polycarbonate aryl hydroxy end-group content of at least 400 ppm; and
wherein an article having a 2 mm thickness and molded from the composition has a near infrared transmission at 960 nanometers, of greater than 50 percent and a Vicat softening temperature of at least 130° C. according to ISO 306 at 120° C./hr and 50 N load.

27. The process of claim 14 wherein an article having a 2.0 mm thickness and molded from the composition has a near infrared transmission at 960 nanometers of greater than 55 percent.

28. The process of claim 14 wherein the composition comprises a product made by a process of melt blending a combination of:
(a) from more than 20 to 60 weight percent of poly(butylene terephthalate);
(b) from 20 to 50 weight percent of an amorphous bisphenol A polycarbonate having a Fries rearrangement of greater than 300 to 10,000 ppm;
(c) from 10 to 40 weight percent glass filler; and
(d) from 0.1 to 5 weight percent of an antioxidant, mold release agent, stabilizer, or a combination thereof;
wherein the melt blended composition has a polycarbonate aryl hydroxy end-group content of at least 500 ppm; and
wherein an article having a 2 mm thickness and molded from the composition has a near infrared transmission at 960 nanometers, of greater than 55 percent and a Vicat softening temperature of 135° C. to 190° C. according to ISO 306 at 120° C./hr and 50 N load.
